(19) United States
(12) Patent Application Publication
(10) Pub. No.: US 2014/0067446 A1
(43) Pub. Date: Mar. 6, 2014

(54) TRAINING DECISION SUPPORT SYSTEMS FOR BUSINESS PROCESS EXECUTION TRACES THAT CONTAIN REPEATED TASKS

(71) Applicants: YURDAER N. DOGANATA, Yorktown Heights, NY (US); GEETIKA TEWARI LAKSHMANAN, CAMBRIDGE, MA (US); MERVE UNUVAR, CAMBRIDGE, MA (US)

(72) Inventors: YURDAER N. DOGANATA, Yorktown Heights, NY (US); GEETIKA TEWARI LAKSHMANAN, CAMBRIDGE, MA (US); MERVE UNUVAR, CAMBRIDGE, MA (US)

(73) Assignee: International Business Machines Corporation, Armonk, NY (US)

(21) Appl. No.: 13/598,185

(22) Filed: Aug. 29, 2012

(51) Int. Cl. G06Q 10/06

(52) U.S. Cl. 705/7.12

(57) ABSTRACT

A method for training a machine learning tool to generate a prediction in a business process includes receiving a business process model corresponding to the business process, the business process model including a plurality of tasks, identifying a cycling set at a decision point in the business process model, wherein the cycling set comprises at least one task that the business process model iterates through, and building a training table by determining a total number of sub-traces and a total number of variables from a plurality of execution traces of the business process model based on the cycling set identified at the decision point, wherein a new row of the training table is created for each of the sub-traces and a new column of the training table is created for each of the variables.

### BACKGROUND OF THE INVENTION

1. Technical Field

The present disclosure generally relates to analytics, and more particularly to analytics for business process management.

2. Discussion of Related Art

Case management challenges require insight, responsiveness, and collaboration. Case management strategy unifies information, processes, and people to provide a complete view of the case. Case management provides analytics, business rules, collaboration, and social software to create more successful case outcomes.

In a semi-structured business process (also referred to as a case), the order of activities to be performed depends on many factors such as human judgment, document contents and business rules. Case workers decide which set of steps to take based on a large amount of data and case information. Given the state of a case which consists of the activities executed and the data consumed or produced in the past, learning and predicting which activities will be performed in the future and how the case is going to end up is important for providing early alerts and guidance. This can also be used for business process simulation, and identifying best business practices. Such decision support analysis requires analyzing the semantics of business process execution traces. A business process execution trace typically includes tasks and data associated with those tasks. For example, consider a business process with 5 tasks, A, B, C, D, and E. A sample trace of the task execution sequence of an instance of this process could be: ABCCCCDE, or ABCDE, or ABCDCDCDE. Each task may have data attributes associated with it which will be logged in the trace along with the execution sequence of the tasks.

Business process execution may include loops. For example, a single task (e.g., A) may loop on itself continuously, creating a pattern in an execution trace such as AAAAAAAA. A loop may include three different tasks A, B and C, and the loop may loop over them multiple times creating a pattern in an execution trace such as ABCABCABCABC. A loop's behavior is reflected in a business process execution trace. A loop can consist of the repeated execution of one or more tasks. A loop is also referred to as a cycle. It is not obvious and nor does existing literature specify how to correctly train machine learning algorithms such as decision trees when there are loops present at a task in a business process that serves as a decision point. A decision point is a point in a business process where execution splits into multiple alternate outcomes, and different outcomes can occur depending on the data attributes present at the decision node.

In general it is not obvious how to extract sufficient information from business process execution traces that contain loops at decision nodes in order to accurately train machine learning algorithms, particularly machine learning algorithms that provide decision support, such as decision trees, or a probabilistic model.

Prior techniques that make predictions about what happens in business processes that contain loops rely on limiting assumptions about the underlying business process. For example, absorption probabilities of Markov Chains, but such a method have a limiting assumption that the process is Markovian (or memoryless).

### BRIEF SUMMARY

According to an embodiment of the present disclosure, a method for training a machine learning tool to generate a prediction in a business process includes receiving a business process model corresponding to the business process, the business process model including a plurality of tasks, identifying a cycling set at a decision point in the business process model, wherein the cycling set comprises at least one task that the business process model iterates through, and building a training table by determining a total number of sub-traces and a total number of variables from a plurality of execution traces of the business process model based on the cycling set identified at the decision point, wherein a new row of the training table is created for each of the sub-traces and a new column of the training table is created for each of the variables.

According to an embodiment of the present disclosure, a method for training a machine learning tool to generate a prediction in a business process may be implemented as a computer readable storage medium embodying instructions executed by a processor for performing method steps.

A method for generating a prediction in a business process including receiving a business process model corresponding to the business process, the business process model including a plurality of tasks, identifying a decision point in the business process model and a plurality of cycling sets occurring at and before the decision point in the business process model, wherein each cycling set comprises at least one task that the business process model iterates through, and building a training table by determining a total number of sub-traces and a total number of variables based on a plurality of execution traces of the business process model, wherein a new row of the training table is created for each of the sub-traces and a new column of the training table is created for each of the variables.

According to an embodiment of the present disclosure, a method for generating a prediction in a business process includes creating a training table based on a business process model corresponding to the business process, the business process model including a plurality of tasks and a cycling set at a decision point in the business process model, wherein the cycling set comprises at least one task that the business process model iterates through, loading the training table into a memory of a machine learning tool; receiving a query and a partial execution trace, and generating the prediction in response to the query based on the partial execution trace and the training table.

BRIEF DESCRIPTION OF THE SEVERAL VIEWS OF THE DRAWINGS

Preferred embodiments of the present disclosure will be described below in more detail, with reference to the accompanying drawings:

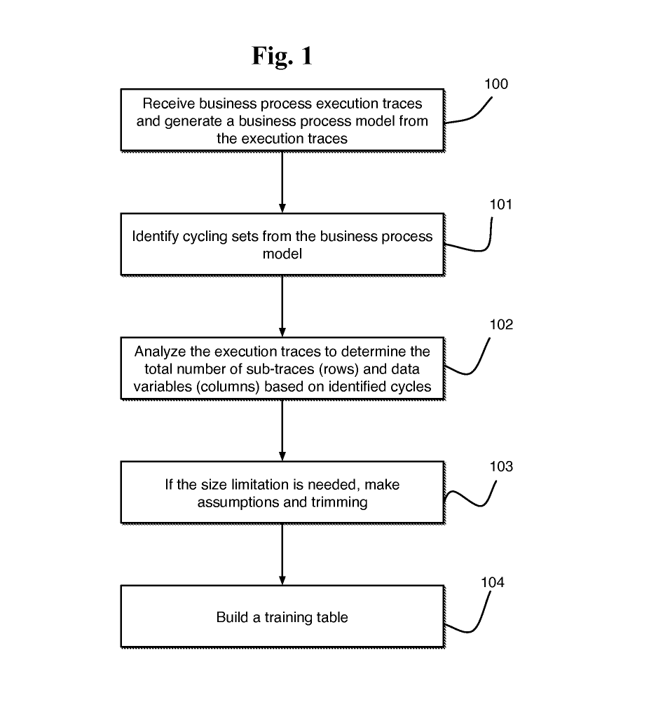

FIG. 1 is an exemplary method for building a training table according to an embodiment of the present disclosure;

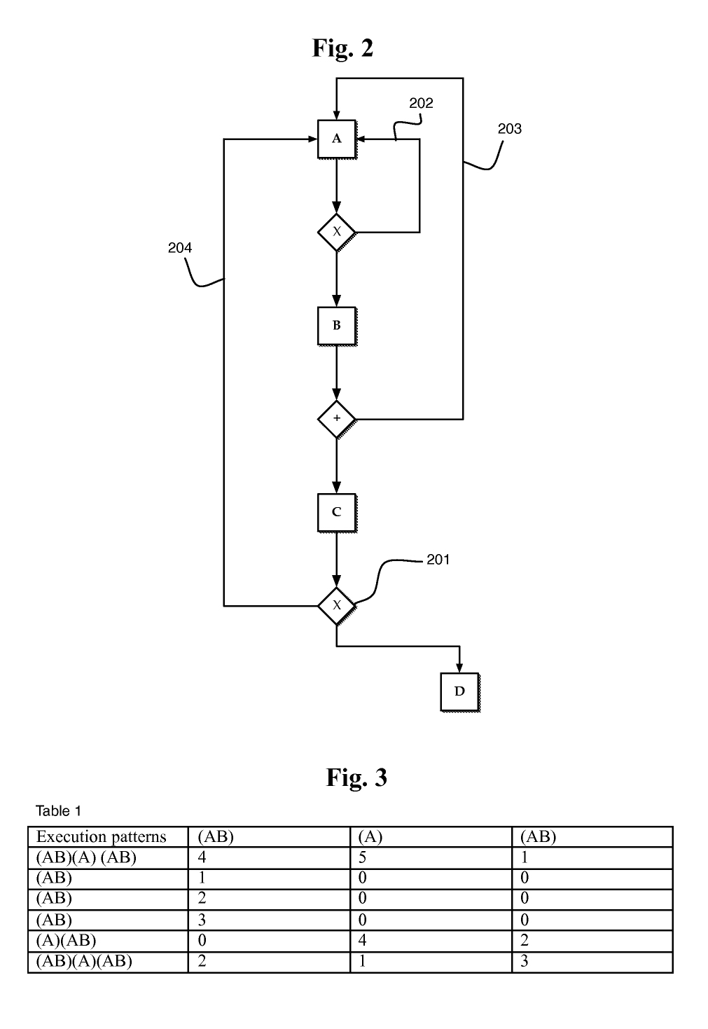

FIG. 2 is a flow diagram of a process model according to an embodiment of the present disclosure;

FIG. 3 is a table (Table 1) showing execution patterns according to an embodiment of the present disclosure;

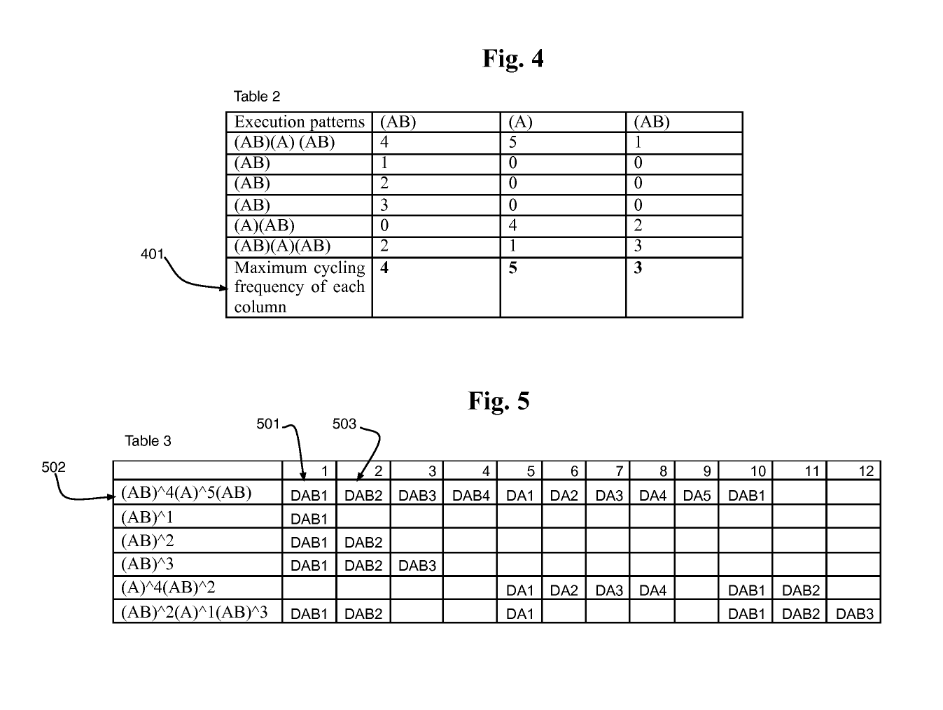

FIG. 4 is a table (Table 2) including information related to a maximum cycling frequency of each column, according to an embodiment of the present disclosure;

FIG. 5 is a table (Table 3) showing an exemplary training table according to an embodiment of the present disclosure;

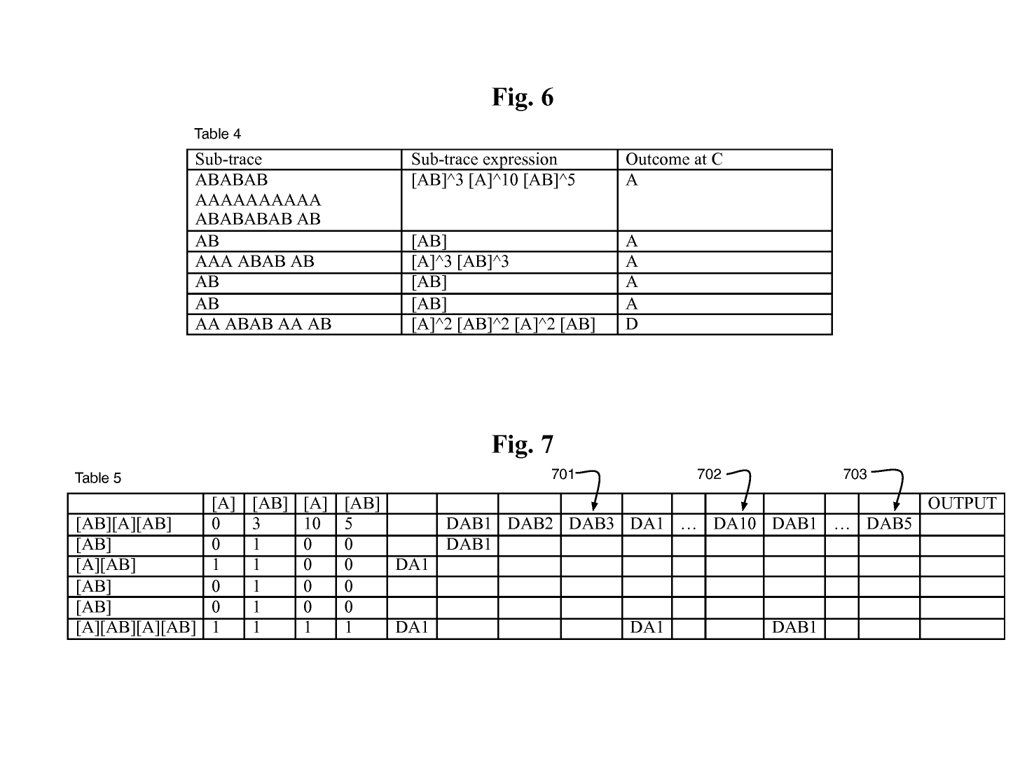

FIG. 6 is a table (Table 4) showing sub-trace instances at a decision point according to an embodiment of the present disclosure;

FIG. 7 is an expanded training table (Table 5) including additional data collected at a decision node according to an embodiment of the present disclosure; and

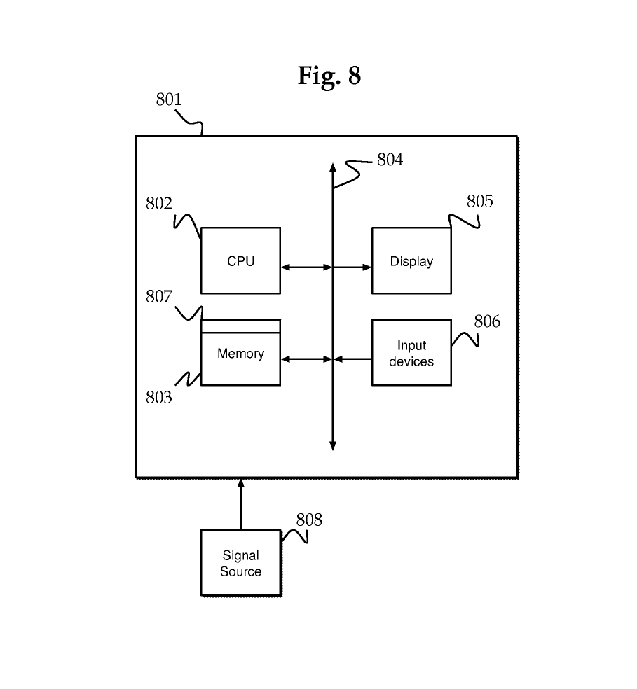

FIG. 8 is an exemplary computer system for performing the method of FIG. 1.

### DETAILED DESCRIPTION

According to an embodiment of the present disclosure, an outcome may be predicted in a business process that contains a cycle or repeated tasks by training decision support systems at decision points. Cycle behavior on an execution path may be captured with new data attributes and information contained in cycles may be incorporated into the training of a machine learning tool for a business process. These new attributes may be used to develop a predictive model. Further predictions may be improved by including the predictive value of cycles into predictive model.

To emphasize the importance of including the impact of cycles in prediction, consider an example from the auto-insurance industry. Auto-insurance is used herein as an exemplary field for the application of training a machine learning tool, however it should be understood that exemplary embodiments described herein may be used in any of a verity of applications and implementations.

In the following description, the terms cycling set and loop may be used to describe the repeated execution of the same ordered sequence of tasks. The terms are synonymous and can be used interchangeably.

According to an embodiment of the present disclosure, predictions may be generated from a probabilistic process model (PPM) mined from case instances of a business processes. The predictions may indicate a likelihood of different outcomes in a currently executing business process instance, such as the likelihood of executing a particular activity in the future given the state of current activity.

The business process may be structured (where the steps and their sequence are known), semi-structured, or unstructured (where the steps and their sequence vary from case to case). In the semi-structured business process (also referred to as a case), the order of activities to be performed may depend on factors such as human judgment, document contents, and business rules. Case workers decide which set of steps to take based on data and case information. Exemplary embodiments are described herein in terms predicting which activities will be performed in the future and how the case ends given state of a case. The state includes the activities executed and the data consumed or produced in the past.

A business process instance includes a sequence of activities or tasks, where each activity may have data associated with it. Turning to the auto-insurance example, an auto-insurance process is typically semi-structured, document driven, with repeated tasks namely cycles. An auto-insurance process starts with a claim. After an insurance claim is opened, the case worker collects documents such as an accident report, personal information about the customer etc. Depending on the document content and personal judgment, case worker needs to make a decision which tasks to conduct next. Typically, a case worker needs to check the consistency of the data that is being collected as a verification process. If there is a mismatch between the records on the database and newly-collected data about the customer, case worker has to repeat his task where he calls back the customer to take more personal information for verification purposes. This “verification” process may cycle back more than once. The way a case worker collects the information during the verification steps may influence the final decision. For example, if the customer provides inaccurate information many times, it is more likely for them to be the faulty party in the accident. If the number of times that customer was called to collect correct information is not taken into account before making predictions with final data, the predictive value of “faulty information” that is gained during the verification step(s) may be missed. Therefore, exemplary methods described herein may improve predictions by including the predictive value of cycles into prediction algorithms.

Cycles are particularly challenging when one needs to extract data from them to train decision trees. For example, consider this cycle in a single execution trace of a business process instance: . . . A B C A B D A B D . . . . This business process has a decision point at task B. In order to train a decision tree (or any machine learning algorithm that provides decision support) at task B, one needs to classify this trace in terms of the outcome from B. However, within this trace, task B could lead to two different outcomes, C or D. Furthermore the trace cycles twice over the outcome D from B. During the execution of a single process instance, decision point is visited multiple times. Every visit to the decision point ends up with a decision. Hence, from every visit training sequence can be extracted for the behavior at the decision node. One aspect of this invention is to teach how to extract the training sequences at each decision point from a single process execution trace. There is no known technique in the prior art on how to extract training sequences from an existing business process execution traces that contain such cycles in order to accurately train decision support systems. Moreover, there is no prior art how to scale and apply such an extraction technique to a complex system. We address all of these problems in this invention.

According to an embodiment of the present disclosure, machine learning tools may be trained to handle cycles to predict what is likely to happen in a data driven instance of a business process containing cycles. If cycles play a role in the decision making process, then training machine learning tools with cycles can provide better prediction accuracy. The importance of a cycle may be manifested in various ways in a business process. For example, either because data changes during the execution of the cycle at a decision point or the number of cycle executions influence the decision making at a decision point. If data changes during the execution of a cycle at a decision point, it affects the decision making logic at the decision point, and therefore needs to be taken into account by a machine learning tool trained at the decision point. If the number of cycle executions in any part of a business process impact the decision making at a decision point, then machine learning tools need to be trained to take this into account in order to accurately predict future outcomes in running instances of the same process.

According to an embodiment of the present disclosure, the need to make assumptions about the underlying process may be eliminated. Stated more generally, an outcome may be predicted in a business process that contains cycle or repeated tasks by training decision support systems at decision points.

It should be understood that any known or future business provenance method may be used to capture, correlate and store events related to an executing business process instance in a trace. Further, any known or future mining method may be used to mine a process model of a business process model from a set of execution traces (see FIG. 1, 100).

According to an embodiment of the present disclosure, a training table may be used to train a machine learning algorithm. The training data table may be generated from execution traces. The training table may be generated by inserting a row for every training instance. Columns of the training table represent the attributes of the training set such as the execution path, number of cycles for each cycling set, data accumulated at every cycle, etc. The values for these data attributes for every instance constitute the entries of the training table. The size of the training table may depend on the number of data attributes (columns) and the training instances (rows).

Referring to FIG. 1, a method for building the training table includes identifying cycling sets that can occur before the decision point from the business process model (101). A cycling set contains the tasks that the process iterates through. For example, in FIG. 2, at decision point C having a decision gateway (201), three cycling sets exist. The cycling sets include [A] (202) and [A B] (203). This can be determined by looking at the business process model itself.

In order to find the rows of the training table, the traces may be analyzed to determine the total number of execution paths up to the decision point (102). As a result of the cycling set (204), from the decision gateway 201 to A, there are a plurality of paths to reach the decision gateway 201 and cycling sets 202 and 203 must be considered for training a machine learning tool at decision gateway 201. These are sub-traces (rows). Sub-traces are subsets of a trace. The first sub-trace starts with start of the trace and stops right before the first occurrence of the decision task. The second sub-trace starts with the task that occurs right after the first occurrence of the decision task and stops right before the second occurrence of the decision task. The third and so forth sub-traces are generated similarly. Hence, the number of rows of the training table is the |number of sub-traces observed before the decision point (C in the example in FIG. 2). For example, forthetrace“A B A B A A A A B C A B A B A A C A B C A A A B A B C D”,that corresponds to an execution of the process in FIG. 2, the following four sub-traces may be extracted:
1) ABABAAAAB
2) ABABAA
3) AB
4) AAABAB

Therefore, for this example, the number of rows for the training table will be four as listed above.

At block (103), the columns of the training table may be identified. The number of columns depends on the data attributes. The first of which is the path information to the decision point as described above. Execution path to the decision point can be expressed by using the task sequences as labels. The length of a label, however, can be arbitrarily long depending on the number of iterations through the cycling set, i.e. ABAA . . . AB. When the number of distinct variables for the execution path is unlimited, training is negatively affected. In order to reduce the number of variables used to describe the execution path, the number of cycles for each set is added as a data attribute and added to the training table as a column. This approach increases the number of columns with continuous data types, but reduces the number of alphanumerical path representation with nominal data type. A variable with continuous data type simplifies the split rules with numerical inequalities in decision trees. Hence, the columns of a training table consist of columns for cycling frequencies, columns for data acquired at every execution of each task including the decision point and a column for the output to be predicted. For example:
Let the trace be ABABABABAAAAAABC ABC ABABC ABABABC AAAAABABC ABABAABABABCD and the decision task is at C again. The execution patterns for this trace may be written as: {(AB)̂4(A)̂5(AB)}, {(AB)̂1}, {(AB)̂2}, {(AB)̂3}, {(A)̂4(AB)̂2}, {(AB)̂2(A)̂1(AB)̂3}. These execution patterns may then be decomposed into sequence of cycling sets and the number of cycles as below:
   {(AB)̂4(A)̂5(AB)}={{(AB)(A)(AB)}, {4}{5}{1}}
   {(AB)̂1}={(AB), {1}}
   {(AB)̂2}={(AB), {2}}
   {(AB)̂3}={(AB), {3}}
   {(A)̂4(AB)̂2}−{(A)(AB), 4, 2}
   {(AB)̂2(A)̂1(AB)̂3}={{(AB)(A)(AB), 2, 1, 3}}

As seen from the example, the pattern that has maximum number of cycling set (AB)(A)(AB) requires three columns to represent the cycling frequencies. Therefore three more columns need to be added in addition to the first column to represent the execution path information fully resulting in the section of the training table shown in Table 1 (FIG. 3).

To find the total number of columns, find the number of columns required for the cycling frequencies, and add the number of columns required for the accumulated data at every task execution. The columns for the cycling frequencies may be found as:

Let x=Number of distinct cycling sets in a sub-trace. For example, for {(A)̂4(AB)̂2}, x=2 since the only cycling sets are (A) and (AB). Number of columns for cycling information is given by:

Max_{all traces} Max_{execution patterns for trace_i} x_i.

This means that the number of distinct cycles is found in all possible execution patterns in all the available execution traces of a business process.

The number of data columns, on the other hand, may be determined by finding a maximum cycling frequency for each column and summing the maximum cycling frequencies, as shown in Table 2 (FIG. 4, 401). Here, a data column is added for every cycle, and each data column stores the value of the data acquired during the execution of that cycle. For the example above, 12 data columns are used (i.e., 4+5+3=12 data columns).

Hence the training table will be modified as shown in Table 3 (FIG. 5) to include a label for every column sets, cycling, data, etc.

In Table 3 (FIG. 5) DAB1 (501) in row 1 and column 1 denotes the data acquired during the execution cycle AB when it was executed for the first time in the execution pattern (AB)̂4(A)̂5(AB) (502). Suppose the data collected in this cycle is <ID, age, gender>. Therefore, this column's cardinality will be 3.

Similarly, DAB2 (503) in row 1 column 2 denotes the data acquired during the execution cycle AB when it was executed for the second time in the execution pattern (AB)̂4(A)̂5(AB) (502). Suppose the data collected in this cycle is <transaction time, age>, this time the cardinality of the corresponding column will be 2.

The age attribute encountered in each iteration of the cycle may be treated as a separate attribute.

In addition to the columns for data and cycling information, if the data that is collected at the decision task has a predictive value, we need to store that data in a separate column. Also, an outcome column for the outcome of the decision may be added.

Hence, the total number of columns of the training table may be given by:

Columns=|Number of cycle columns|+SUM|Cardinality of each data columns|+1+k

wherein k=|Cardinality of data at decision point|, if the data at the decision point is important and k=0, if data at decision point is not important. In this context, importance refers to whether the data impacts the decision. The importance of data can be determined by looking at the correlation of the data attributes with its output.

If the size of the training table may be limited by trimming the number of columns. Exemplary methods for trimming the training table are described below.

The number of iterations may be very large in a few cases that do not repeat often. These may be exceptional cases that are not likely to occur. Adding a column for each cycle to represent such exceptional cases may increase the number of columns without adding a significant value to the training process. These columns will typically store zero values. Discarding these columns, which constitutes the tail of the distribution of the number of iterations in the cycling sets, may reduce the number of columns. A user may control how many, or the degree to which, columns are trimmed.

Further simplifications are possible. For example, if incremental data collection does not provide any additional value, then the method may take only the most recent data that is collected at an end of each cycling set (a last iteration of a cycle). That is, for each cycling set, at least one intermediate iteration may be performed prior to the end of the cycling set. For example, suppose that the data collected in the first iteration of a cycle AB is <ID=2, age=5, gender=Female>. Now suppose that the data collected during the second and last iteration of the same cycle is <ID=2, age=null, gender=Male>. Therefore, with the introduced simplification, the data collected for cycle AB may be recorded as <ID=2, gender=Male>. In this case, the number of columns may be reduced to (Number of columns=2|number of cycle columns|+1+k, where

k−|Cardinality of data at decision point|, if data at decision point is important

k−0, if data at decision point is not important.

Having discussed a general strategy for creating a training table, a specific example will be described in view of FIG. 2. A sample trace associated with FIG. 2 may be given as:
A B A B A B A A A A A A A A A A A B A B A B A B A B C A B C A
A A A B A B A B C A B C A B C A A A B A B A A A B C D and more preciesly as:
ABABAB AAAAAAAAAA ABABABAB ABCABC AAA ABAB
ABCABCABC AA ABAB AA ABC

All cycles that happen before a decision point may be identified. Since decision point is at C in FIG. 2, the trace may be sub-divided into sub-traces whenever C is visited as (recall that there are two different cycle types given as [A] and [AB] in FIG. 2). The cycling tasks in the execution trace path can also be expressed by indicating the number of cycles instead of repeating the task sequence at every cycle. Hence, the trace [ABABAB] can be expressed [AB]̂3. Each time a decision point is visited, a decision is produced. The sub-traces that produce a decision form training sequences. For the example, the training sequences and the associated decision are given in the Table 4 (FIG. 6).

The task “C” need not be included in the sub-traces since each sub-trace will end with C. That is, there may not be significant information to be gained for training purposes due to having C at the end of all sub-traces.

Since infinite cycles may occur theoretically, the number of sub-trace expressions may greatly expand. Each sub-trace is a training sequence and adds a row to the instances table. As a result, a number of rows may greatly expand as well. One way of controlling the expansion of the sub-trace expressions is to separate the cycling frequencies from the expressions and add a column for every possible cycling set.

Every time a decision point is visited, the information about the execution path is kept by the sub-trace expression and the cycling columns record the cycling time of each cycle. The data accumulated incrementally at the end of each task is additional information that may be impacting the result of the prediction. If this is the case, then information about the data at every task should also be collected and kept. Keeping the incremental data at every task, however, may not scale well. In the example above, if the data at the end of each cycle needs to be kept, then to represent the incremental data for the first row we would need 3+10−5=18 columns assuming that the cardinality of each data vector is 1. The total number of columns that is needed to represent the data behavior of the whole trace is the maximum number of columns required for each sub-trace. In cases where only the data accumulated at the last cycle instance is important, the number of columns will be limited to the number of different cycles traversed before the decision. As an example, for the first row, DABS (701), DA10 (702) and DABS (703) are given with this strategy, for example, see Table 5 (see FIG. 7).

In some cases, additional data may be collected at the decision node and that data might be carrying some predictive properties. If this is the case, additional columns may be added to the table for the data at decision point C as DC, which contains the data vector at C.

It is to be understood that embodiments of the present disclosure may be implemented in various forms of hardware, software, firmware, special purpose processors, or a combination thereof. In one embodiment, a method for predictive analytics for document content driven processes may be implemented in software as an application program tangibly embodied on a computer readable storage medium or computer program product. As such the application program is embodied on a non-transitory tangible media. The application program may be uploaded to, and executed by, a processor comprising any suitable architecture.

Referring to FIG. 8, according to an embodiment of the present disclosure, a computer system 801 for generating prediction in a business process that contains a cycle or repeated tasks can comprise, inter alia, a central processing unit (CPU) 802, a memory 803 and an input/output (I/O) interface 804. The computer system 801 is generally coupled through the I/O interface 804 to a display 805 and various input devices 806 such as a mouse and keyboard. The support circuits can include circuits such as cache, power supplies, clock circuits, and a communications bus. The memory 803 can include random access memory (RAM), read only memory (ROM), disk drive, tape drive, etc., or a combination thereof. The present invention can be implemented as a routine 807 that is stored in memory 803 and executed by the CPU 802 to process the signal from the signal source 808. As such, the computer system 801 is a general-purpose computer system that becomes a specific purpose computer system when executing the routine 807 of the present invention.

The computer platform 801 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described embodiments for generating prediction in a business process that contains a cycle or repeated tasks, it is noted that modifications and variations can be made by persons skilled in the art in light of the above teachings. It is therefore to be understood that changes may be made in exemplary embodiments of disclosure, which are within the scope and spirit of the invention as defined by the appended claims. Having thus described the invention with the details and particularity required by the patent laws, what is claimed and desired protected by Letters Patent is set forth in the appended claims.

1. A method for training a decision support system using machine learning to generate a prediction in a business process, the method comprising:
receiving a business process model corresponding to a business process, the business process model including a plurality of tasks;
identifying a cycling set at a decision point in the business process model, wherein the cycling set comprises a repeated execution of an ordered sequence of tasks from the business process model;
determining a total number of cycle executions for the identified cycling set;
building a training table by determining a total number of sub-traces and a total number of variables from a plurality of execution traces of the business process model based on the cycling set identified at the decision point, wherein a new row of the training table is created for each of the sub-traces and a new column of the training table is created for each of the variables; and
training a decision support system with the built training table using machine learning
wherein the training of the decision support system includes taking into account the determined total number of cycle executions for the identified cycling set, which is stored as one or more columns in the training table, and
wherein each of the above steps are performed using one or more computer systems.

2. The method of claim 1, wherein the variables correspond to data attributes and at least one data attribute indicates path information to the decision point.

3. (canceled)

4. The method of claim 1, further comprising trimming the training table.

5. The method of claim 4, wherein building the training table includes adding data to the training table acquired at every execution of the cycling set, the method further comprising trimming at least one column of the training table corresponding to an intermediate iteration of the cycling set.

6. The method of claim 1, wherein data added to the training table corresponding to the cycling set is limited to data corresponding to an end of the cycling set.

7. A method for generating a prediction in a business process using a decision support system, the method comprising:
building a training table based on a business process model corresponding to a business process, the business process model including a plurality of tasks and a cycling set at a decision point in the business process model, wherein the cycling set comprises a repeated execution of an ordered sequence of tasks from the business process model, and wherein the training table further includes a determined total number of cycle executions for the cycling set stored as one or more columns thereof;
training a decision support system with the built training table using machine learning,
wherein the trainin of the decision su ort s stem includes takin nto account the determined total number of cycle executions for the cycling set;
receiving a query and a partial execution trace; and
generating a prediction in response to the query and the partial execution trace using the trained decision support system,
wherein each of the above steps are performed using one or more computer systems.

8. The method of claim 7, wherein the query comprises a partial execution trace of a current execution.

9. The method of claim 7, wherein building the training table comprises:
identifying the cycling set at the decision point in the business process model; and
determining a total number of sub-traces and a total number of variables based on a plurality of execution traces of the business process model, wherein a new row of the training table is created for each of the sub-traces and a new column of the training table is created for each of the variables.

10. The method of claim 9, wherein the variables correspond to data attributes and at least one data attribute indicates path information to the decision point.

11. (canceled)

12. The method of claim 9, further comprising trimming the training table.

13. The method of claim 12, wherein building the training table includes adding data to the training table acquired at every execution of the cycling set, the method further comprising trimming at least one column of the training table corresponding to an intermediate iteration of the cycling set.

14. The method of claim 9, wherein data added to the training table corresponding to the cycling set is limited to data corresponding to an end of the cycling set.
